(19) United States
(12) Patent Application Publication
(10) Pub. No.: US 2024/0291067 A1
(43) Pub. Date: Aug. 29, 2024

(54) MULTI-PURPOSE CELL SEPARATION ELEMENT FOR A BATTERY ARRANGEMENT OF A MOTOR VEHICLE, BATTERY ARRANGEMENT AND MOTOR VEHICLE

(71) Applicant: AUDI AG, Ingolstadt (DE)

(72) Inventors: Tobias ENZINGER, Hohenwart (DE); Andreas KOPP, Kösching (DE)

(73) Assignee: AUDI AG, Ingolstadt (DE)

(21) Appl. No.: 18/405,210

(22) Filed: Jan. 5, 2024

(30) Foreign Application Priority Data
Feb. 24, 2023 (DE) 102023104603.9

(51) Int. Cl. H01M 10/6555; H01M 10/613; H01M 10/6569; H01M 50/204; H01M 50/249; H01M 50/291; H01M 50/293

(52) U.S. Cl. CPC H01M 10/6555; H01M 10/613; H01M 10/6569; H01M 50/204; H01M 50/249; H01M 50/291; H01M 50/293; H01M 2220/20

(57) ABSTRACT

A battery arrangement with a battery module, which includes a cell stack with multiple battery cells arranged next to one another in a stacking direction and one or more cell separation elements. One of the cell separation elements is arranged between respective two battery cells arranged adjacent to one another. At least one of the cell separation elements protrudes on one side of the cell stack from a gap between the two battery cells, in which the cell separation element is arranged. The protruding cell separation element is connected to an active cooling device through which a cooling medium can flow and which is encompassed by the battery arrangement.

### FIELD

The invention relates to a battery arrangement with a battery module, which has a cell stack with multiple battery cells arranged next to one another in a stacking direction and one or more cell separation elements, wherein one of the cell separation elements is arranged between respective two battery cells arranged adjacent to one another. Furthermore, the invention also relates to a cell separation element and a motor vehicle.

### BACKGROUND

Cell separation elements can be provided between the battery cells of a battery module. These can take on various functions, such as insulating the battery cells electrically and thermally from one another. In addition, when operating a high-voltage battery, the battery cells also need to be cooled. The bottom of a battery housing is therefore often used as a cooling base and a cooling medium flows through it. The cooling structure of a battery should generally be designed to minimize the risk of cooling water in the high-voltage battery in the event of a leak in such a cooling structure.

U.S. Pat. No. 8,541,126 B2 describes a battery with a multi-sided housing, a first and a second housing wall and an upper and lower housing wall. Furthermore, the battery comprises multiple battery cells that are arranged in the housing and at least one thermal barrier element that divides the battery into multiple cell groups, wherein each cell group comprises at least two battery cells and wherein the thermal barrier element extends completely from the first to the second housing wall and from the upper to the lower housing wall. The thermal barrier element also consists of three layers and can also be connected to cooling.

### SUMMARY

The object of the present invention is to provide a battery arrangement, a cell separation element and a motor vehicle which make it possible to increase the cooling of the battery cells of a battery module without compromising safety.

A battery arrangement according to the invention comprises a battery module, which has a cell stack with multiple battery cells arranged next to one another in a stacking direction and one or more cell separation elements, wherein one of the cell separation elements is arranged between respective two battery cells arranged adjacent to one another. At least one of the cell separation elements protrudes on one side of the cell stack from a gap between the two battery cells in which the cell separation element is arranged, wherein the protruding cell separation element is connected to an active cooling device through which a cooling medium can flow and which is encompassed by the battery arrangement.

The invention is based on the realization that the cell separation elements arranged between the battery cells, which actually fulfill a different function, namely that of thermally insulating the battery cells from one another, can also be used as a cooling for the battery cells. However, in order to avoid the risk that cooling water, for example, can get into the battery module or come into contact with the battery cells due to a leak in the cooling system, the cell separation elements or at least one of these cell separation elements are designed here as passive cooling elements, which means that these cell separation elements themselves are not flowed through or can be flowed through by a cooling medium, but are instead connected at one end to a cooling device through which a cooling medium can flow. This can be arranged, for example, outside the battery module or the cell stack. In addition, it can be arranged in a position where more installation space is available, in order to make it more robust, for example with regard to possible damage, for example due to an external force. The cell separation elements can therefore be designed to be extremely thin and therefore space-saving, which makes it possible to provide such a cell separation element in every gap between two adjacent cells. This flow-through cooling device can also be, for example, an existing cooling device of the battery, which comprises the battery module, such as the cooling base mentioned at the beginning. This means that no additional installation space is required. The fact that the cell separation elements can be additionally cooled also increases their thermally insulating effect, for example in the event of a thermal event in one of the battery cells. In other words, thermal spread of such a thermal runaway of a cell to other neighboring cells can be prevented more efficiently or can be delayed for a longer period of time. It is also particularly advantageous that the battery module is designed in such a way that such a cell separation element is provided between two battery cells arranged adjacent to one another in the stacking direction. This not only creates a significantly better thermal barrier in the event of thermal runaway of a battery cell, in and against the stacking direction, but also leads to significantly more homogeneous cooling of the respective battery cell, since such a battery cell can be in contact with a coolable cell separation element on both sides and is therefore cooled symmetrically. This leads to even more efficient cooling of the battery cells. Overall, significantly more efficient cooling of the battery cells can be provided without compromising safety in any way. Rather, this design of the battery module allows additional safety measures to be integrated into a battery module, which provide very great advantages, especially in the event of a thermal event.

The battery cells can be prismatic battery cells or pouch cells, for example. The battery cells can be formed as lithium-ion cells, for example. The battery module is preferably a battery module for a high-voltage battery of a motor vehicle. The battery module itself can also be designed as a high-voltage battery module. In other words, the voltage that can be tapped from the battery module can be in the high-voltage range. Between two battery cells arranged next to each other in the stacking direction there is a gap in which such a cell separation element is arranged. In at least one direction perpendicular to the stacking direction, such a cell separation element therefore has a dimension that is larger than the corresponding dimension of the gap or of the adjacent cells. This direction can be defined as the first direction, for example. The side of the cell stack on which the at least one cell separation element protrudes thus limits the cell stack in this first direction. This side of the cell stack can also be called the first side. The at least one cell separation element therefore protrudes out of the cell stack in this first direction. The cell separation element can also taper. The protruding part of the cell separation element may have a lower height, for example in a second direction that is perpendicular to the stacking direction and to the first direction, than within the gap, in which the height preferably corresponds substantially to the height of the adjacent cells. Based on the intended installation position of the battery module in the motor vehicle, the side, namely the first side, can be any side of such a battery module, for example a top side, a bottom side, a left or right side. It is also conceivable that the cell separation element protrudes from the gap not only on one side, but also, for example, on two, for example opposite, sides or even on more than two sides, for example on three sides or all four sides. This enables multiple connection of the protruding part of the relevant cell separation element to such an active cooling device, that is, a cooling structure through which a cooling medium can flow. Such a cooling structure can be designed accordingly with cooling channels through which such a cooling medium can flow. In particular, the cooling device is preferably designed so that a liquid cooling medium, for example water, flows through it during operation. This enables a particularly efficient cooling. The cooling device can be provided, for example, by a base, cover or side wall of a battery housing or module housing. However, the cooling device can be provided specifically for the purpose of cooling the cell separation elements and, for example, can also be designed as a line, for example as a pipe or hose, which passes through the protruding portions of the cell separation elements and is connected to them at the passage points and thereby cools them.

In addition, all cell separation elements are preferably designed in the same way or can be designed in the same way. In other words, it is preferred that each of the cell separation elements of the battery module protrudes on at least one side from the relevant gap between two adjacent cells in which the corresponding cell separation element is arranged. Different cell separation elements can also protrude from this gap on different sides of the cell stack. For example, a second cell separation element can protrude on a second side of the cell stack from this gap in which this second cell separation element is arranged. The second side can be different from the first side of the cell stack defined above and can, for example, be arranged opposite one another. However, the second cell separation element does not necessarily have to protrude from the gap in or against the first direction, but can, for example, also protrude in or against a second direction that is perpendicular to the first direction and to the stacking direction.

Further features and exemplary embodiments are described below in relation to the at least one of the cell separation elements, which protrudes from the gap between the two adjacent battery cells on the side of the cell stack. These features and embodiments can therefore apply in the same way to all other cell separation elements included in the battery module, without this being explicitly mentioned each time.

Furthermore, it can be provided that no further element is arranged in a gap between two battery cells arranged adjacently in the stacking direction, other than the cell separation element. In other words, the cell separation element is the only element that is arranged at such a gap between two battery cells of the battery module.

In a further advantageous embodiment of the invention, the at least one cell separation element is designed in a single layer and as a metallic plate, in particular as a solid metallic plate. This represents a particularly simple, efficient and, above all, space-saving design option for the cell separation element. In principle, it is preferred that such a cell separation element takes up as little space as possible in the stacking direction and, for example, has a thickness of only a few millimeters in the stacking direction, for example a maximum of one to two millimeters. This can be achieved particularly easily by designing it as a simple plate, in particular a solid plate. In addition, metals or alloys are usually very good thermal conductors, which means that particularly efficient cell gap cooling can be provided via these cell separation elements through the connection to the active cooling structure. Another very huge advantage of such a metallic plate is that metals are very robust and, depending on the design, can also have a very high melting point. As a result, the cell separation element forms a very good thermal barrier, especially also in the event of thermal runaway of a battery cell, not only due to the cooling provided, but also a mechanical barrier. Destruction of the cell separation element in the event of a thermal event caused by the occurring very high temperatures can thereby advantageously be avoided. As a result, the functionality of the cell separation element can be guaranteed and maintained even in such a case. For example, the metallic plate can be made of steel or iron or stainless steel. But other metals with preferably the highest possible melting point can also be used for this, in particular alloys.

In this example, there is only one such metallic plate in such a gap between two battery cells of the battery module arranged adjacent to one another. This protrudes from the cell gap on at least one side and is connected to an active cooling device.

In a further advantageous embodiment of the invention, the at least one of the cell separation elements has a first plate made of a first material, which provides the part of the protruding cell separation element that protrudes on the side, wherein the cell separation element has a second plate made of a second material which is designed in a way that the second plate has a lower specific thermal conductivity than the first plate, in particular wherein the first plate is formed from a metallic material and the second plate is formed from a ceramic material.

The first plate can therefore be designed as described for the metallic plate according to the previous exemplary embodiment. The first plate is therefore preferably made of a metallic material, in particular solid, and with the highest possible melting point, for example steel, stainless steel or iron. In addition, the first plate, especially if it is made of a metallic material, also has very good thermal conductivity, which is particularly advantageous in order to achieve cell heat dissipation. The thermal barrier between the cells can be further strengthened by the additional second plate, which should have a significantly lower thermal conductivity than the first plate and can be designed, for example, as a ceramic layer, ceramic plate, ceramic paper or similar. This can then advantageously ensure a particularly good thermal barrier between the cells in the event of a thermal event, and for example in the event of a failure of the active cooling. In this example, the cell separation element has a two-layer structure when viewed in the stacking direction or consists of two layers arranged next to one another in the stacking direction, at least within the gap. However, the second plate does not have to protrude from the gap on any side. In other words, it can be provided that the second plate is arranged exclusively within this gap between two adjacently arranged cells. However it is still conceivable that this protrudes from the gap on one side. Preferably, however, the part of the cell separation element which contains the active cooling device or another cooling element which is thermally connected to the active cooling device is provided only by the first plate and not by the second plate. The second plate therefore advantageously does not affect the thermal coupling to the cooling device.

There may or may not be a connection between the two plates. These two plates can, for example, be glued to each other or something similar. The two plates thus form a unit that is easy to position and handle. However, a connection between the two plates is not necessary. The second plate can also be designed as ceramic paper.

The term plate is intended to express that this element is a very thin element, which therefore has a thickness in the stacking direction that is orders of magnitude smaller than, for example, a length or width of the corresponding element perpendicular to the stacking direction. The term “plate” should not imply that it must also be a non-flexible, rigid element. For example, the first plate can also be provided in the form of a thin metal sheet and/or the second plate in the form of a ceramic paper. A plate can generally also be understood as a layer.

The second plate can also be provided as a coating on the first plate. Regardless of this, it is preferred that the second material also has the highest possible melting point, in particular above at least 100 degrees Celsius, in particular above several 100 degrees Celsius. This means that the heat-insulating properties can still be guaranteed even in the event of a thermal event.

In a further advantageous embodiment of the invention, the battery arrangement, in particular the battery module, has a housing in which the cell stack is arranged, wherein the housing comprises a housing wall. The protruding part of the cell separation element provides a coupling surface which is arranged on the housing wall, wherein an active cooling device is provided by the housing wall or the housing wall is connected to the active cooling device in a thermal and in particular physical manner, or wherein the protruding part of the cell separation element is led out through an opening in the housing wall to the outside of the housing and is connected to the cooling device, in particular at least one cooling line through which a cooling medium can flow.

The protruding part of the cell separation element can therefore either be connected to a housing wall, for example of the battery module, or can be led out of the battery module and out of the module housing through an opening in this housing wall. There is also the possibility that the housing wall itself is designed as a cooling device, that is to say has cooling channels through which a coolant can flow, through which a coolant flows when the battery module is in operation, or that the housing wall itself does not represent an active cooling device, but is thermally connected to one, and in particular is also connected to it in a mechanically contacting manner. For example, the housing wall can be a side wall of the battery module housing, which is in contact with a bottom cooling system of a battery housing. This provides a thermal path from the cell separation element via the housing wall of the battery module housing to the cooling base of the battery housing. The cell separation element can, for example, also be connected directly to the base or cover, or also a side wall or partition, of such an overall battery housing, through which the active cooling device is provided.

Multiple battery modules can be arranged in a battery housing or overall battery housing. Each battery module can also optionally have its own additional module housing.

If the cell separation element with the protruding part is also led out of the housing wall, in particular of the module housing, the cell separation element can also be connected directly to a cooling device that is different from the module housing. This cooling device can, for example, be provided as part of an overall battery housing, in which, for example, multiple such battery modules can be arranged to provide a high-voltage battery. In other words, for example, the cell separation element can be led out of the module housing through a corresponding opening and connected directly to a cooling base of the overall battery housing. Such a connection should in particular always be understood to mean a mechanical connection. In other words, the cell separation element can be arranged in contact with the corresponding housing wall and/or cooling device.

Furthermore, if multiple cell separation elements are to be led out through corresponding openings, the housing wall can have a corresponding opening, for example a slot-shaped opening, for each cell separation element. However, the housing wall can also be designed with a larger recess, which extends, for example, in the stacking direction over the entire battery module or almost the entire battery module, so that all cell separation elements can be led out through a common opening in the housing wall to the outside of the housing.

As already mentioned, the cooling device can also be provided by a cooling line through which a cooling medium can flow. In particular, a plurality of such cooling lines can optionally be provided, to which the cell separation elements can be connected. The connection can in particular be such that this cooling line passes through the protruding parts of the respective cell separation elements, for example through a corresponding respective opening or a hole in the cell separation elements, wherein a mechanical and thermal contact is established between the line and the cell separation elements. The direction of the cooling line can be, so to speak, parallel to the surface normal of the cell separation elements or the cooling line can extend parallel to the stacking direction. The connection of the cooling line to the corresponding cell separation elements, in particular to the metallic plates described above, can, for example, be designed similarly to a plate heat exchanger, but in this case the cell separation elements and in particular the respective first plates should not themselves be flowed through, not event potentially, by a cooling medium.

In a further advantageous embodiment of the invention, the cell separation element is designed such that its thermal conductivity changes, in particular is reduced, when a temperature of the cell separation element reaches or exceeds a certain limit value. This can advantageously be achieved, especially in the event of a thermal event in which very high temperatures arise, in that the thermal barrier between the cells increases additionally, in that the thermal conductivity of the cell separation element decreases in such a case. This means that the battery cells are thermally decoupled from each other even better. This makes it even more difficult for such a thermal event to spread to neighboring cells.

The specific limit value is preferably above a normal operating temperature range of the battery module. This normal operating temperature range preferably has an upper limit of a maximum of 80 degrees Celsius or even less. In other words, the temperature-related change in the thermal conductivity of the cell separation element should not begin in a normal, proper operating state of the battery module, but should only be triggered at higher temperatures, in particular higher than 80° C. or 90° C. or higher than 100° C. This configuration advantageously makes it possible for a thermal event itself to trigger the change in thermal conductivity of the cell separation element. Advantageously, no control of the cell separation element is required in order to bring about or trigger the change in thermal conductivity. This advantageously provides a particularly efficient passive protection mechanism.

In a further very advantageous embodiment of the invention, the cell separation element has a phase change material which at least partially carries out a phase transition at the specific temperature, in particular from a first solid state of matter to a liquid or gaseous second state of matter or from a liquid first state of matter to a gaseous second state of matter. The phase change material can therefore be such that it carries out a phase transition at the specific temperature and, for example, at a defined pressure, which corresponds, for example, to a standard pressure or normal pressure, for example 1.013 bar. Such a phase transition removes an enormous amount of energy from the environment, which advantageously has a cooling effect. If, for example, there is a thermal runaway of a battery cell adjacent to the cell separation element, the thermal energy released by the battery cell can be absorbed by the cell separation element and fed to the phase change material, which then heats up to a certain temperature and then at least partially carries out the phase transition. A further supply of thermal energy to the cell separation element does not lead to further heating of the cell separation element, but is used to carry out the phase transition through the phase change material until the phase transition is completed, namely the entire phase change material is in the second aggregate state. This allows the temperature spread to other cells to be avoided even more efficiently. In addition, such a phase transition can also ensure that the thermal conductivity of the cell separation element changes, as already mentioned above.

Therefore, it represents a further very advantageous embodiment of the invention if the cell separation element is designed such that at least part of the phase change material escapes from the cell separation element and from the gap in which the cell separation element is arranged after at least partial phase transition. In the simplest case, the phase change material can, for example, be water, which escapes in gaseous form from the cell separation element or the gap after the phase transition has been carried out. By an escape of such a phase change material, the thermal conductivity of the cell separation element can also be changed, in particular reduced, in a simple manner. This advantageous design allows a double effect to be achieved, which has a particularly positive effect in the event of a thermal event. On the one hand, carrying out the phase transition removes an enormous amount of energy from the environment, which leads to cooling or prevents further heating of the cell separation element, and in addition, the thermal conductivity of the cell separation element is reduced, which increases the thermal barrier between the cells.

The phase change material can be such that it has a larger volume in the second physical state than in the first state. The increase in volume can be used, for example, to open an opening in the cell separation element for the exit of the phase change material, for example as a kind of predetermined breaking point. For this purpose, it is not absolutely necessary that the entire phase change material has already completed the phase change. If this opening opens, it can also be provided that the portion of the phase change material that has not yet transitioned to the second aggregate state can also escape from the cell separation element.

In a further advantageous embodiment of the invention, the cell separation element has a receiving structure part with a receiving structure in which the phase change material is accommodated, at least when the temperature of the cell separation element is lower than the specific limit value, in particular at a standard pressure. In this case, the receiving structure part provides the part of the protruding cell separation element that protrudes on the side, wherein the receiving structure itself, for example recesses or cavities provided in the receiving structure part, which form the receiving structure in their entirety, does not have to extend beyond the gap and preferably actually does not extend beyond the same. The phase change material received in the receiving structure is therefore preferably only located within the gap between two cells. The protruding part of the cell separation element can, for example, be solid, or at least lack the receiving structure. The receiving structure part can be provided, for example, by a plate with integrated recesses, wherein the phase change material can be accommodated in these recesses. The plate can, for example, be designed as a metallic plate, in particular also the protruding part. This plate is at least not completely designed as a solid plate, but rather has corresponding cavities or something similar. To seal from the outside, the corresponding recesses can be closed or sealed with caps or a film or corresponding plugs or valves, so that, for example, a liquid phase change material in the normal state, namely the liquid state, cannot escape so easily. These closed recesses can simultaneously serve as predetermined breaking points, which, when the phase change material undergoes the phase change, break, tear, or otherwise open or are destroyed due to its increase in volume, whereby the phase change material can escape from the cell separation element. As already described, the phase change material does not have to have completely carried out the phase change. In other words, if the phase change material is water, for example, not all of the water has to have evaporated before these predetermined breaking points open. The predetermined breaking points can open earlier and the gaseous water and, depending on the current position or arrangement of the cell separation element, also the remaining water that has not yet evaporated can escape from the cell separation element. This automatically creates air-filled gaps in the cell separation element, which reduce the thermal conductivity of the cell separation element, since air in particular is a very good thermal insulator.

It is also conceivable to use a material as the phase change material that is solid in the normal state and which, for example, melts above the limit temperature. For example, plastics or wax or resin or the like are conceivable. This allows the phase change material to flow out of the receiving structure of the cell separation element leaving air-filled gaps, which reduces the thermal conductivity. Closures of the receiving structures are then not absolutely necessary, but can still be provided.

Such a closure can also be designed in such a way that it is destroyed, for example by melting, above a certain temperature due to the thermal effect.

Furthermore, the invention also relates to a cell separation element for a battery module, wherein the cell separation element is designed as one of the cell separation elements of a battery arrangement according to the invention or one of its embodiments, in particular as the protruding cell separation element. The cell separation element can therefore be the previously described cell separation element. The features and embodiments mentioned for the cell separation element of the battery arrangement according to the invention and its embodiments should therefore apply in the same way to the cell separation element according to the invention and provide further corresponding forms of the cell separation element.

The invention also includes further developments of the cell separation element according to the invention, which have features as already described in connection with the battery arrangement according to the invention and the further developments of the battery cell arrangement according to the invention. For this reason, the corresponding developments of the method according to the invention are not described again here.

Furthermore, the invention also relates to a motor vehicle having a battery arrangement according to the invention or one of its embodiments.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations that each have a combination of the features of a plurality of of the described embodiments, provided that the embodiments have not been described as mutually exclusive.

### BRIEF DESCRIPTION OF THE FIGURES

Exemplary embodiments of the invention are described hereinafter. In particular:

FIG. 1 shows a schematic representation of a part of a high-voltage battery with a battery module according to an exemplary embodiment of the invention;

FIG. 2 shows a schematic representation of a battery arrangement with a battery module in plan view according to a further exemplary embodiment of the invention.

FIG. 3 shows a schematic and perspective representation of a battery module according to a further exemplary embodiment of the invention.

FIG. 4 shows a schematic exploded representation of two battery cells of a battery module having a cell separation element according to an exemplary embodiment of the invention;

FIG. 5 shows a schematic representation of a cell separation element for a battery module according to a further exemplary embodiment of the invention;

FIG. 6 shows a schematic representation of a cell separation element provided with a phase change material for a battery module according to a further exemplary embodiment of the invention;

FIG. 7 shows a schematic representation of a part of a cell separation element with a phase change material according to an exemplary embodiment of the invention; and

FIG. 8 shows a schematic illustration of a part of a cell separation element with a phase change material according to a further exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

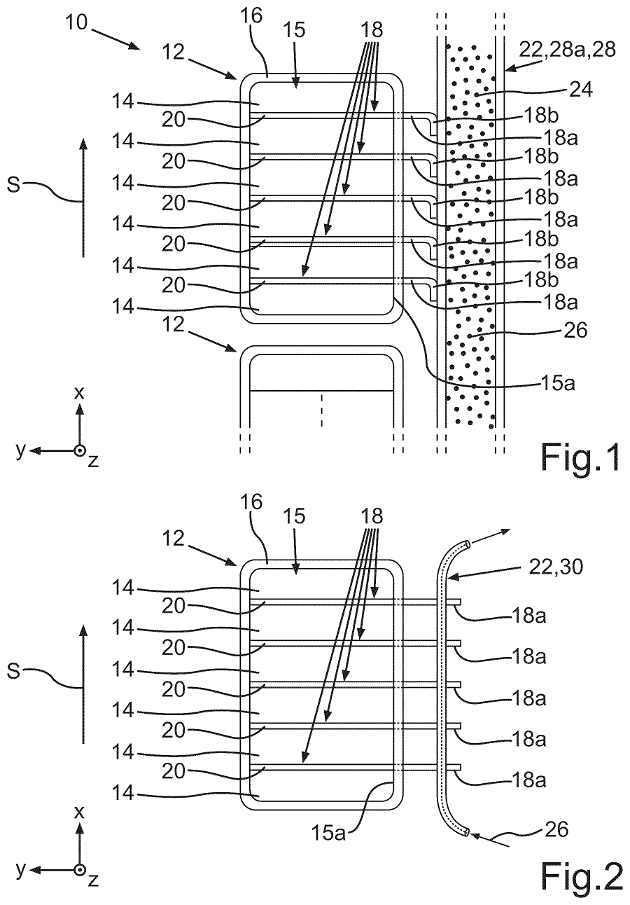

FIG. 1 shows a schematic illustration of a part of a battery arrangement formed, for example, by a battery 10 with a battery module 12 according to an exemplary embodiment of the invention. The battery 10 can, for example, be designed as a high-voltage battery for a motor vehicle and include not only one battery module 12, but also a plurality of battery modules 12. A second battery module 12 is also partially shown in FIG. 1. The battery module 12 comprises a cell stack 15 with multiple battery cells 14 arranged next to one another in a stacking direction S. In this example, the stacking direction S runs parallel to the x-direction of the coordinate system shown. Furthermore, the battery module 12 includes a battery module housing 16 in which the battery cells 14 are arranged. In addition, the battery cells 14 can be designed, for example, as prismatic battery cells.

A cell separation element 18 is also arranged between two battery cells 14 arranged next to one another in the stacking direction S.

The cell separation elements 18 are now advantageously designed so that they protrude on at least one side 15a of the cell stack 15 from the gap 20 between two cells 14 arranged adjacently in the stacking direction S, in which the respective cell separation element 18 is arranged. The respective protruding part of the cell separation element 18 is designated 18a in the present case. In the present case, each of the cell separation elements 18 is connected to an active cooling device 22 of the HV battery 10 via its part 18a protruding from the cell stack 15. This cooling device 22 accordingly has at least one cooling channel 24 through which a coolant, preferably a liquid coolant, can flow. The coolant is designated 26. In the example shown in FIG. 1, the protruding parts 18a of the respective cell separation elements 18 are curved at their respective end, which faces the cooling device 22. The protruding ends 18a thus have an L-shaped cross section based on a cross-sectional plane perpendicular to the z direction shown, which in the present case is perpendicular to the stacking direction S, and perpendicular to the y direction, against which the cell separation elements 18 protrude from the cell stack 15. This bend advantageously provides a contact region 18b, via which the respective protruding part 18a is connected to the cooling device 22 in a flat manner.

The cooling device 22 can be, for example, a cooling wall 28a or a cooling base of an overall battery housing 28 of the battery 10, in which the plurality of battery modules 12 are accommodated.

This has the great advantage that active cell cooling can also be provided by the cell separation elements 18, namely indirectly via the active cooling device 22. Advantageously, no elements through which a cooling medium flows need to be introduced between the cells 14, and the gap 20 between the cells 14 can still be used to integrate cell cooling.

FIG. 2 shows a schematic representation of a battery module 12 according to an exemplary embodiment of the invention. This can be as described for FIG. 1, except for the differences described below: These consist primarily in the fact that the ends 18a of the cell separation elements 18 protruding from the cell stack 15 are now not connected to a cooling device 22 designed as a cooling wall 28, but instead to a cooling line 30, which can be designed, for example, as a pipe or hose. This line 30 also provides a cooling channel 24 through which a coolant 26 can flow. In addition, the respective ends of the protruding parts 18a of the cell separation elements 18 in the present case are not designed to be curved, but can, for example, have a respective through opening through which the line 30 can be passed through the respective cell separation elements 18, in particular plate-shaped cell separation elements 18. As a result, the line 30 is in thermal and physical contact with each of the cell separation elements 18. As a result, heat can be dissipated particularly efficiently via the coolant 26 flowing through this line 30. The connection of the line 30 to the individual cell separation elements 18 can, for example, be carried out in a similar way to plate heat exchangers, except that in the present case the cell separation elements 18 are not themselves flowed through or can be flowed through by a coolant 26.

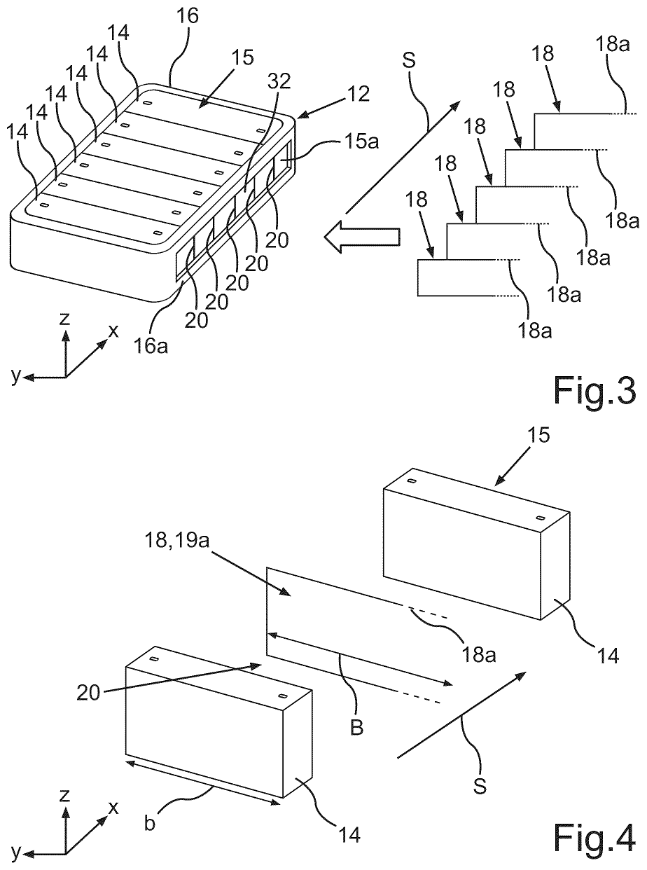

FIG. 3 shows a schematic illustration of a battery module 12 according to an exemplary embodiment of the invention. This battery module 12 can also be designed as described above, in particular like the battery module 12 described in FIG. 1 or FIG. 2. In this illustration, the respective cell separation elements 18 are now shown outside the remaining battery module 12 for better illustration and are not yet arranged between the cells 14. In order to enable the corresponding protruding parts 18a, which are indicated here by the dashed parts of the cell separation elements 18, to also be led out of the module housing 16, a housing wall 16a can be designed, for example, with a corresponding recess 32 or through opening 32. In this example, a common such opening 32 is provided in the side 16a of the module housing 16 for all cell separation elements 18 of the battery module 12. If the cell separation elements 18 are arranged in their intended position between the cells 14, as shown for example in FIG. 1 or FIG. 2, the protruding parts 18a accordingly protrude from this opening 32 in the housing 16.

Alternatively, the side 16a may not be formed with a common opening 32 for all cell separation elements 18, but instead, for example, with a respective, for example slot-shaped opening for each of the cell separation elements 18. The corresponding slots providing the openings can, for example, run in the z shown and completely penetrate the housing 16 in the y direction.

Furthermore, it is also conceivable that the cell separation elements 18 are not led out of the housing 16 with their respective ends 18a, but are instead connected to a housing wall of the housing 16. Such a connection can, for example, be carried out analogously to the example shown in FIG. 1 of connecting the ends 18a to the overall battery housing wall 28a. The corresponding module housing wall of the module housing 16 can also be an active cooling device 22 or this housing wall of the module housing 16 can be connected to an active cooling device 22 in another way. This can be provided, for example, by a cooling base of the overall battery housing 28.

In addition, there are numerous advantageous options for designing or designing the respective cell separation elements 18, which will now be explained in more detail below. A first example is shown schematically in an exploded view in FIG. 4. FIG. 4 shows in particular two battery cells 14 of a battery module 12, which can be designed as described above. The corresponding cell separation element 18 is arranged in a gap 20 between the two battery cells 14, which element in this example is designed as a simple, solid metallic plate or sheet 19a. FIG. 4 shows in particular this metallic plate 19a in relation to the respective neighboring cells 14 in an exploded view. When arranged in the modules 12 as intended, this metallic plate 19a rests flatly on the respective sides of the adjacent battery cells 14 facing the plate 19a. The plate 19a is designed such that it has a width B in a direction perpendicular to the stacking direction S, which is greater than a width b of the adjacent cells 14 in the same direction. In this example, this represents the y-direction. As a result, the plate 19a protrudes on one side out of the gap 20 between the cells 14 and can therefore advantageously be connected to a cooling structure or active cooling device 22. The protruding part 18a of the cell separation element 18 is again indicated by the dashed part of the plate 19a. The geometric design of this protruding part 18a can be designed depending on the desired type of connection to the active cooling 22, for example in FIG. 1 or FIG. 2.

The cell separation element 18 is now designed, so to speak, as a cell gap flag with a protruding part 18a. The metallic plate 19a may be formed of a simple, thermally conductive material for good heat dissipation with a high melting point for a good mechanical barrier, for example iron, steel, stainless steel or the like. In the stacking direction S, however, the plate 19a can be designed with an extremely small thickness, which is, for example, only a few millimeters or even just one or two millimeters or less.

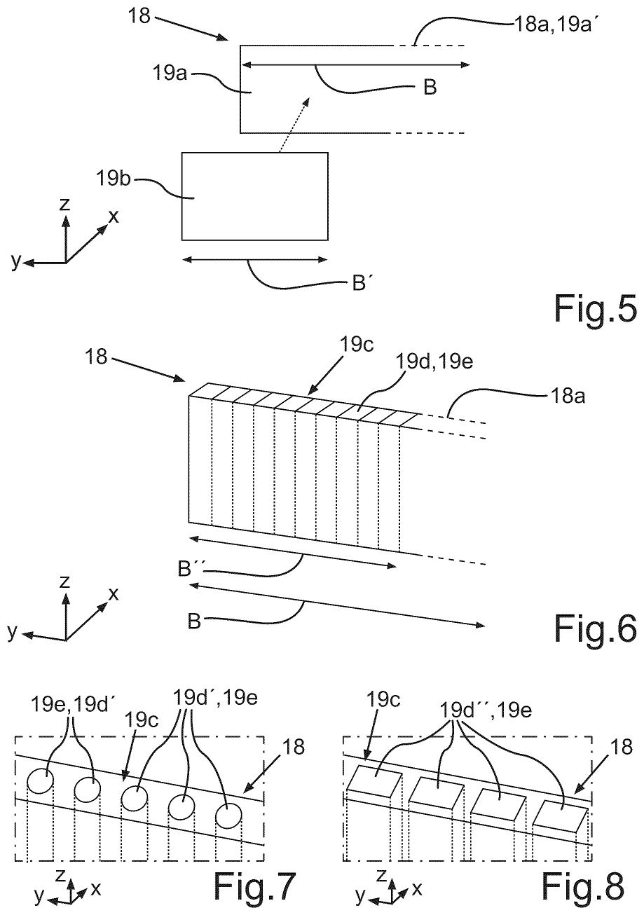

FIG. 5 shows a schematic exploded representation of a cell separation element 18 for a battery module 12 according to a further exemplary embodiment of the invention. In this example, the cell separation element 18 now has, on the one hand, a first plate 19a, which can in particular be designed as a metallic plate 19a, for example as described in FIG. 4, and a second plate 19b, which, however, consists of a different material, which is such that the second plate 19b has a lower thermal conductivity than the first plate 19a. For example, the second plate 19b can be made of a ceramic material, and can be formed, for example, as a ceramic plate or ceramic paper. As a result, the second plate 19b provides a particularly good heat-insulating plate or a heat-insulating strip. The thermal decoupling of the cells 14 from each other is thus further improved, which is particularly advantageous in the event of a thermal event. If this cell separation element 18 is arranged as intended between a first cell 14 and a second cell 14, which represent two adjacently arranged cells 14 of a cell stack 15, then the first plate 19a, and in particular not the second plate 19b, is in contact, preferably in flat contact, with the first cell 14, and the second plate 19b, and in particular not the first plate 19a, in contact, preferably in flat contact, with the second cell 14 of the two cells 14. If such cell separation elements 18 are between two adjacent cells 14 of a cell stack 15, these cell separation elements 18 are all oriented the same with regard to the orientation of the first and second plates 19a, 19b and the two opposite cell sides of a respective cell 14, which are adjacent to a cell gap 20, in particular at least the cells 14, which do not represent edge cells of the cell stack 15, are each in contact with a first plate 19a of a cell separation element 18 and with a second plate 19b of a further cell separation element 18. This has the effect that with the composite design (conductive and insulating) of the cell separation element 18, each cell 14 is primarily cooled on one side by the separating element 18 and is primarily insulated from the neighboring cell 14 by the cell separation element 18 on the other side.

The second plate 19b can also be applied as a coating on the first plate 19a or can be provided as a separate plate or paper, although a material connection to the first plate 19a does not necessarily have to be provided. In the y direction, this second plate may also have a width B′, which is reduced compared to the width B of the first plate 19, and which may correspond, for example, to the width b of a corresponding adjacent cell 14. In other words, the extent of the second plate 19b can be limited to the gap 20 between the cells 14. Theoretically, the second plate 19b can also protrude beyond this gap 20, however, the part 18a of the cell separation element 18 connected to the cooling structure 22 should preferably be provided solely by an end 19a′ of the first plate 19a.

Furthermore, the cell separation element 18 does not have to be designed to be rigid, but can also be designed to be flexible to a certain extent due to its small thickness in the stacking direction S.

FIG. 6 shows a schematic illustration of a cell separation element 18 according to a further exemplary embodiment of the invention. In this example, the cell separation element 18 has a receiving structure part 19c with receiving structures or receiving regions 19d, in which a phase change material 19e is received, which carries out a phase transition above a certain limit temperature. At normal pressure, this specific limit temperature is above the intended operating temperature of the battery cells 14. During normal operation of the battery module 12, this phase change material 19e is present, for example, in solid or liquid form. If the phase change material 19e heats up to the limit temperature, further supply of thermal energy is used for the phase transition and the phase change material 19e becomes, for example, liquid or gaseous. Furthermore, the cell separation element 18 is designed such that at least the part of the phase change material 19e that has already carried out the phase transition can escape from the cell separation element 18.

The cell separation element 18 can therefore be designed as a cell gap body with a hollow body structure, wherein the hollow bodies 19d provided can be filled by the hollow body structure, for example with a fluid 19e that evaporates at high temperatures. The cell gap body, i.e. the cell separation element 18, thereby dissipates heat to the outside at normal temperature, since the receiving structure part 19c is preferably designed to have good thermal conductivity, for example by being made of metallic material, and can also be connected to the cooling device 22 via a respective end 18a, as previously described. The cell separation element 18 also thermally insulates the cells 14 from each other in the case of thermal propagation, since only the cavity structures 19d remain due to the escape of the phase change material 19e from the cell separation element 18 after at least partial phase transition and thus after escaping from the gap 20 between the cells 14, wherein the cavities 19d provided by these structures 19d are now filled with air. This reduces the thermal conductivity of the cell separation element 18 as a whole and the cells 14 are better thermally shielded from one another.

The hollow structures 19d can take on various geometric shapes, as illustrated in FIGS. 7 and 8. FIG. 7 shows hollow structures 19d′, which are cylindrical in shape, and FIG. 8 shows hollow structures 19d″, which are prismatically formed with a rectangular base. In general, these structures can be prismatic with any base surface geometry, for example triangular. These hollow structures can also be closed via appropriate caps or foils or closures or the like, which allow escape during evaporation or generally during the phase transition of the phase change material 19e. These closures can, for example, be designed as predetermined breaking points.

As illustrated in FIG. 6, these hollow cell structures 19d, i.e. the region of the cell separation element 18, in which hollow bodies 19d are present, extend over a width B″, which is preferably smaller than the total width B of the cell separation element 18 in the direction, presently the y-direction, in which the cell separation element 18 protrudes from the gap 20 out of the cell stack 15. In other words, this hollow body structure 19d can be limited to the region between the cells 14, that is to say to the gap 20. The width B″ can, for example, be as large as the width B′ of the second plates 19b of the example in FIG. 5. The protruding part 18a can in turn be designed as a solid plate or flag or similar.

The hollow structures 19d or the cavities 19d extend in the z-direction in the examples shown in FIGS. 6, 7 and 8 and are arranged next to one another in the y-direction. Alternatively, the hollow structures 19d or the cavities 19d can also extend in the y direction and/or be arranged next to one another in the z direction. The z-direction corresponds, for example, to a vehicle vertical direction of a motor vehicle based on a preferred installation position in this motor vehicle. A horizontal design of the hollow structures 19d is thus also possible. The releasable openings or possibly permanently released, namely permanently open, openings of the structures 19d can be located on the cell separation element 18 at the top and/or bottom in relation to the z-direction or also to the left or right in relation to the y-direction, but preferably on one side of the cell separation element 18 that does not provide the end 18a of the cell separation element 18.

Polymers or waxes or other materials can also be used and provided as phase change material 19e, which are solid below the limit temperature and then run out of the cell separation element 18, for example when the limit temperature is exceeded. For this embodiment, there does not have to be a closure of the hollow structures 19d, and the phase change material 19e then simply runs outwards on the sides of the cell stack 15.

Overall, the examples show how the invention can provide cell gap cooling through modified propagation barriers. The loss of installation space, which in principle has to be accepted by providing propagation barriers, can be efficiently compensated for by designing the barriers for additional cooling between the cells. At the same time, propagation behavior can be improved. Overall, this leads to better electrical performance due to improved cell gap heating without having to resort to cooling water in the high-voltage battery.

1. A battery arrangement with a battery module, which comprises a cell stack with multiple battery cells arranged next to one another in a stacking direction and one or more cell separation elements, wherein one of the cell separation elements is arranged between respective two battery cells arranged adjacent to one another,
wherein at least one of the cell separation elements protrudes on one side of the cell stack from a gap between the two battery cells, in which the cell separation element is arranged,
wherein the protruding cell separation element is connected to an active cooling device through which a cooling medium can flow and which is encompassed by the battery arrangement.

2. The battery arrangement according to claim 1, wherein at least one of the cell separation elements is designed in a single layer and as a metallic plate, in particular as a solid metallic plate.

3. The battery arrangement according to claim 1, wherein the at least one of the cell separation elements has a first plate made of a first material, which provides the part of the protruding cell separation element that protrudes on the side, wherein the cell separation element has a second plate made of a second material which is designed in a way that the second plate has a lower specific thermal conductivity than the first plate, in particular wherein the first plate is formed from a metallic material and the second plate is formed from a ceramic material.

4. The battery arrangement according to claim 1, further comprising a housing in which the cell stack is arranged, wherein the housing comprises a housing wall,
wherein the protruding part of the cell separation element provides a coupling surface which is arranged on the housing wall, wherein the active cooling device is provided by the housing wall or the housing wall is connected thermally, and in particular also physically, in contact with the active cooling device; or
wherein the protruding part of the cell separation element is led out through an opening in the housing wall to the outside of the housing, and is connected to the cooling device, in particular at least one cooling line through which a cooling medium flows.

5. The battery arrangement according to claim 1, wherein the cell separation element is designed such that its thermal conductivity changes, in particular is reduced, when a temperature of the cell separation element reaches or exceeds a certain limit value.

6. The battery arrangement according to claim 1, wherein the cell separation element comprises a phase change material which carries out a phase transition at the specific temperature, in particular from a solid state of matter to a liquid or gaseous state of matter, or from a liquid state of matter to a gaseous state of matter.

7. The battery arrangement according to claim 1, wherein the cell separation element is designed such that at least part of the phase change material escapes from the cell separation element and from the gap in which the cell separation element is arranged after at least partial phase transition.

8. The battery arrangement according to claim 1, wherein the cell separation element has a receiving structure part with a receiving structure in which the phase change material is accommodated, at least when the temperature of the cell separation element is lower than the specific limit value, wherein the receiving structure part provides the part of the protruding cell separation element which protrudes on the side.

9. A cell separation element for a battery module, wherein the cell separation element is designed as one of the cell separation elements of the battery arrangement according to claim 1.

10. A motor vehicle having a battery arrangement according to claim 1.

11. The battery arrangement according to claim 2, further comprising a housing in which the cell stack is arranged, wherein the housing comprises a housing wall,
wherein the protruding part of the cell separation element provides a coupling surface which is arranged on the housing wall, wherein the active cooling device is provided by the housing wall or the housing wall is connected thermally, and in particular also physically, in contact with the active cooling device; or
wherein the protruding part of the cell separation element is led out through an opening in the housing wall to the outside of the housing, and is connected to the cooling device, in particular at least one cooling line through which a cooling medium flows.

12. The battery arrangement according to claim 3, further comprising a housing in which the cell stack is arranged, wherein the housing comprises a housing wall,
wherein the protruding part of the cell separation element provides a coupling surface which is arranged on the housing wall, wherein the active cooling device is provided by the housing wall or the housing wall is connected thermally, and in particular also physically, in contact with the active cooling device; or
wherein the protruding part of the cell separation element is led out through an opening in the housing wall to the outside of the housing, and is connected to the cooling device, in particular at least one cooling line through which a cooling medium flows.

13. The battery arrangement according to claim 2, wherein the cell separation element is designed such that its thermal conductivity changes, in particular is reduced, when a temperature of the cell separation element reaches or exceeds a certain limit value.

14. The battery arrangement according to claim 3, wherein the cell separation element is designed such that its thermal conductivity changes, in particular is reduced, when a temperature of the cell separation element reaches or exceeds a certain limit value.

15. The battery arrangement according to claim 4, wherein the cell separation element is designed such that its thermal conductivity changes, in particular is reduced, when a temperature of the cell separation element reaches or exceeds a certain limit value.

16. The battery arrangement according to claim 2, wherein the cell separation element comprises a phase change material which carries out a phase transition at the specific temperature, in particular from a solid state of matter to a liquid or gaseous state of matter, or from a liquid state of matter to a gaseous state of matter.

17. The battery arrangement according to claim 3, wherein the cell separation element comprises a phase change material which carries out a phase transition at the specific temperature, in particular from a solid state of matter to a liquid or gaseous state of matter, or from a liquid state of matter to a gaseous state of matter.

18. The battery arrangement according to claim 4, wherein the cell separation element comprises a phase change material which carries out a phase transition at the specific temperature, in particular from a solid state of matter to a liquid or gaseous state of matter, or from a liquid state of matter to a gaseous state of matter.

19. The battery arrangement according to claim 5, wherein the cell separation element comprises a phase change material which carries out a phase transition at the specific temperature, in particular from a solid state of matter to a liquid or gaseous state of matter, or from a liquid state of matter to a gaseous state of matter.

20. The battery arrangement according to claim 2, wherein the cell separation element is designed such that at least part of the phase change material escapes from the cell separation element and from the gap in which the cell separation element is arranged after at least partial phase transition.
